(19) United States
(12) Patent Application Publication
(10) Pub. No.: US 2010/0112292 A1
(43) Pub. Date: May 6, 2010

(54) SEPARATOR FOR STACKING OF CYLINDRICAL OBJECTS

(75) Inventor: James W. Gilfert, Eldred, PA (US)

Correspondence Address: BASCH & NICKERSON LLP, 1777 PENFIELD ROAD, PENFIELD, NY, 14526, US

(73) Assignee: Fibercel Packaging, LLC, Portville, NY (US)

(21) Appl. No.: 12/613,041

(22) Filed: Nov. 5, 2009

Related U.S. Application Data
(60) Provisional application No. 61/112,151, filed on Nov. 6, 2008.

(51) Int. Cl. B32B 3/00

(52) U.S. Cl. 428/156

(57) ABSTRACT

Disclosed herein are fiber-formed shipping and storage separators for handling, transportation and retention of a plurality of cylindrical objects, such as rolls of web material, compressed gas cylinders, etc.

Applicant claims priority under 35 USC §119 from U.S. Provisional Application 61/112,151 for a “SEPARATOR FOR STACKING OF CYLINDRICAL OBJECTS,” by J. Gilfert, filed Nov. 6, 2008, which is also hereby incorporated by reference in its entirety.

The disclosed system is directed to shipping and storage separators for the handling, transport and retention of a plurality of cylindrical objects, such as rolls of web material, compressed gas cylinders, etc. Structural materials used to fabricate such separators are preferably eco-friendly and recyclable, as well as bio-degradable. In the embodiments disclosed, these roll separators are distinctively designed to include geometric profiles that serve to provide structural rigidity and thereby reinforce or add strength to a material that is otherwise relatively insubstantial. The disclosed embodiments are directed to an improved shipping separator, and more particularly to a separator that enables a plurality of cylindrical objects to be stacked and stabilized, one on top of the other in a rectangular, palletized arrangement. The improved separator design also facilitates, in one embodiment, the ability to be nested one upon another, thereby resulting in a total stack height approximating the sum of the wall thickness of the individually nested separators—a degree of nesting not previously obtained with similar cellulose-type separators, and one that reduces shipping costs for the separators themselves.

### BACKGROUND AND SUMMARY

The palletizing of cylindrical objects requires the horizontal stacking of rolled or tubular items into uniform tiers, however, due to the propensity for the items to roll towards or away from one another a separator is required to stabilize a plurality of round objects having a common diameter when they are palletized or stored. Multiple separators are typically used to enable a multitude of rolled stock to be stacked for storage and/or shipping. Cylindrical commodity items, as noted above, may include rolled webs of paper, plastic film, sheet metals such as aluminum and steel, roofing membranes and materials, floor coverings and the like, but may also take the form of other generally cylindrical objects such as tanks, pipes or even logs. The elongated separators include a number of evenly spaced semi-cylindrical indentations or recesses along with side walls and various geometric features, such as ribs, strategically positioned so as to offer adequate strength and thereby prevent the complete crushing and collapse of the separator yet provide cushioning between the items to avoid damaging them, while at the same time controlling or limiting movement of the items thereon during shipping.

Moreover, it is desirable that such packaging separators be both lightweight, recyclable and/or made from recycled, or at a minimum, biodegradable materials. Accordingly, molded pulp, (aka papier-mâché) in accordance with one embodiment of the separator, is considered to be a lightweight and cost-effective material that originates from up to 100% recycled materials and is biodegradable. In view of this requirement, the molded material is made, in one embodiment discussed below, from recycled cellulose or other fibrous or pulp materials. While various mixtures of materials are possible, including about 100% newsprint or about 100% Kraft fibers, in one of the embodiments disclosed herein separators were made with 60% Kraft paper and about 40% newsprint and then mixed with water or another carrier and deposited onto a mold having a porous surface. It will be appreciated that a variety of alternative materials may also be employed, including various pulps, cellulose, sugar cane and palm waste, as well as expanded starches.

The elongated roll separator is preferably constructed in the form of a side-by-side pair of roll separators which are conjoined to each other along a flexible, perforated joint or hinge to facilitate folding in half and then to be placed between the top of one tier of items and the bottom of another, or in the alternative split along the joint to be used under a bottom tier of items and on the top of the upper tier of items.

Packing material, by its very nature, is bulky because it is required to fill in the voids between the product and/or an associated shipping container. Conventional fiber roll separators, albeit not fillers, remain relatively bulky to transport and store because a non-uniform wall thickness of the pulp molding process interferes with efficient stacking of the separators, and accordingly consumes excessive shipping and storage volume—leading to higher delivered cost for conventional separators. In order to reduce the gap between nested separators, and producing a denser and more “nestable” separator, a post-molding operation includes compressing of the backside of the fiber form with a secondary die, after the front side has been drawn into the primary mold. This secondary compression process, while adding a step to a conventional fiber molding process, results in a two-fold improvement to the separator, increased density and strength of the molded material as well as a more controlled cross-sectional (wall) thickness.

The increased material density resulting from the secondary compression, at least about 5.5 gms/cubic in. (equivalently ˜18 lbs/ft³ or ˜306 kg/m³), preferably at least about 7.0 grams/cubic in., (equivalently ˜30 lbs/ft³ or ˜484.4 kg/m³) and more preferably at least about 7.9 gms/cubic in. (equivalently ˜34 lbs/ft³. or ˜544.6 kg/m³) improves structural stability (stiffness measured in lbf/in) and the uniform material thickness also eliminates weak spots caused by voids and stress risers within the walls of the roll separator. An additional advantage of the secondary compression operation is exhibited in the ability to more closely stack or nest the separators onto one another, and in so doing decreasing the stack height, as well as the unit volume of a quantity of separators, by approximately 65% as compared to conventional fiber separators—thereby requiring only about one third of the prior shipping/storage space for the same quantity or separators. Accordingly, the shipping, warehouse and production savings in the storage/transport of closely nested separators can be allotted to other storage needs or in the alternative can be used to store additional separators and allow for the purchase of higher quantities to realize reduced freight costs.

In order to further encourage the “nesting” of the separators, opposing vertical walls include a draft angle of about 20-25 degrees, which refers to the taper or slope away from a vertical reference line that is perpendicular to the base of the separator. Additionally, the draft angle is advantageous in providing a compressive reactive force along a composite vector line of the individual horizontal and vertical wall forces.

It is, therefore, an object of the present invention to provide an improved biodegradable separator for handling, shipping and storing generally cylindrical items by increasing the material density using post molding compaction or compression operation.

It is a further objective to provide roll separators having a substantially uniform wall thickness so as to minimize gaps or spaces when one separator is nested within another, thereby significantly increasing the number of separators that may be shipped or stored in a given space. It is yet a further object to minimize voids and separations between the fibers of the material to reduce stress or stress concentration and thereby provide a fiber-based biodegradable separator with improved performance.

In accordance with an aspect of the disclosed embodiments, there is provided a fiber-formed separator for restraining a tiered stack of items, said separator comprising: an elongated member having a face side surface and an opposing back side surface; a plurality of arcuate contact surfaces on the first side of the elongated member, disposed to receive and maintain separation of the items; a divider cavity, extending between the arcuate contact surfaces and having a depression therein; a longitudinal reinforcing recess formed within the arcuate contact surface; an outer wall, extending about the entire periphery of said elongated member, where said outer wall has an inward draft of at least about 20 degrees; and the separator having a thickness, between the face side surface and the back side surface, between about 2.0 mm (0.079 in) to about 5.0 mm (0.197 in), to enable substantial nesting of the separator.

In accordance with another aspect of the disclosed embodiments, there is provided a plurality of fiber-formed separators for restraining a tiered stack of generally cylindrical items, each of said separators comprising: an elongated member having a face side and an opposing back side surface; a plurality of arcuate item contact surfaces on the first side of the elongated member, disposed to receive and separate the generally cylindrical items; a divider cavity, extending between the arcuate item contact surfaces and having a depression therein; a longitudinal reinforcing recess formed within each arcuate item contact surface; an outer wall, extending about the entire periphery of said elongated member, where said wall has an inward draft of at least about 20 degrees; and the separator having an average material density of at least about 5.5 grams/cubic in.

Additional objects, features and advantages will be apparent and the disclosed embodiments more readily understood from a reading of the following specification and by reference to the accompanying drawings forming a part thereof, wherein the examples of the various embodiments are given for the purposes of disclosure.

### BRIEF DESCRIPTION OF THE DRAWINGS

The drawings are only for purposes of illustrating various embodiments and are not to be construed as limiting, wherein:

FIG. 1 is a perspective view of an unfolded separator;

FIG. 2 is an illustration of the separator embodiment from a generally top view;

FIG. 3 is perspective view of the separator of FIG. 1 in the folded position and readied for use;

FIG. 4 is the same perspective view of the embodiment in FIG. 1 showing the ability to nest a plurality of separators;

FIG. 5 is an isolated view of the singular separator of FIG. 4;

FIG. 6 is an illustrative example of the underside of a segment of the separator depicting the load bearing surface areas;

FIG. 7 is a perspective view of the underside of a separator;

FIG. 8A is a side view of a separator;

FIG. 8B is a cutaway view of FIG. 2;

FIG. 8C is a cutaway view illustrating the wall thicknesses;

FIG. 9 is a photographic view of the roll separator in use;

FIGS. 10A and 10 B are an illustration of several nominal dimensions of the separators; and

FIG. 11 is an illustration of the improved separator relative to a conventional fiber separator; and

The various embodiments described herein are not intended to limit the disclosed embodiments to those described. On the contrary, the intent is to cover all alternatives, modifications, and equivalents as may be included within the spirit and scope of the disclosure as well as any appended claims.

### DETAILED DESCRIPTION

The embodiments disclosed herein include a geometric configuration for the roll separator, however it is further contemplated that the separator disclosed may also be used to store and ship items other than traditional rolled web materials. Moreover, the separators may be produced in various shapes and sizes to accommodate different roll or other item geometries (e.g., elliptical and oval cross sections). Therefore, the use of the term “roll” or “item” is not intended to limit the disclosure or claims to rolled materials alone, but also includes all objects comprising a generally cylindrical form factor.

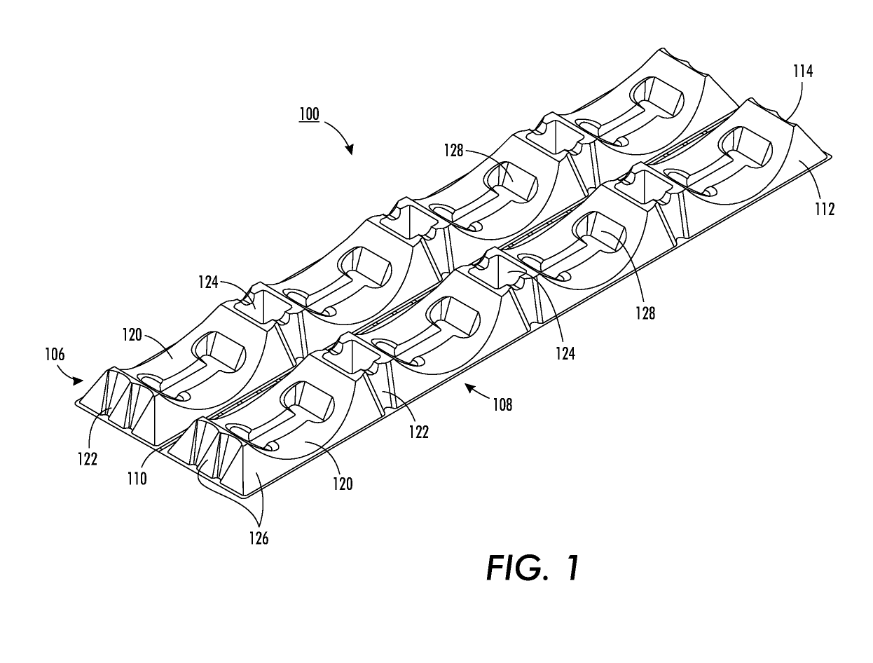

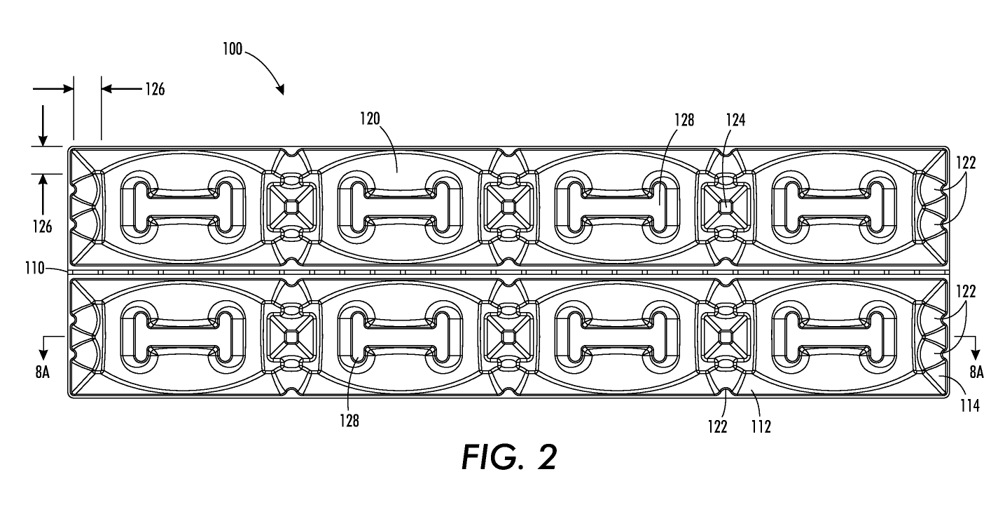

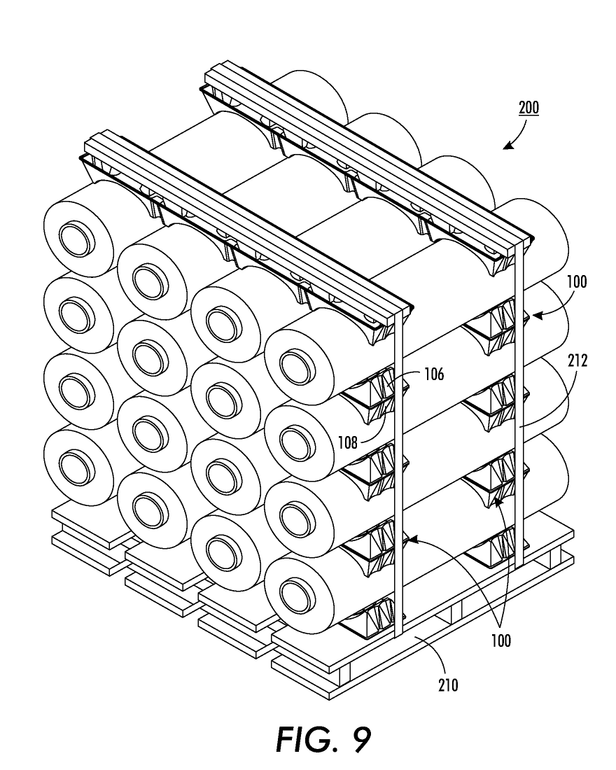

Preferably, as seen in FIG. 1, roll separators 100 are molded in pairs which are flexibly joined or “hinged” along adjacent edge portions at joint 110 between the respective base portions 106 and 108. Ideally, flexible joint 110 is formed by reducing the thickness of the molded material so only a thin portion of material connects the pairs, thereby reducing the resistance to bending and allowing the separator pairs to fold back onto each other. An alternative method for producing a hinge includes perforations, either cut or cast into the adjoining sections of roll separator 100 (as illustrated in more detail along joint 110 in FIG. 2). This method is generally considered preferable when the roll separator pairs are to be used individually as the base separator of the first layer and on the top of the last layer of rolls to allow for strapping, as shown in FIG. 9. The use of perforations assures that the base portions 106 and 108 may be easily separated from one another by repeatedly folding along joint 110 and then tearing or slicing the joint.

Continuing to refer to FIGS. 1 and 2, roll spacer 100 includes a rather intricate topography having a multitude of angles, bridges, cavities, depressions and indentations, all of which when viewed in combination, synergistically provide a sturdy and economical separator for storing and shipping cylindrical items. For example the “dog bone” shaped cavity 128, as best seen in FIG. 2, is strategically molded into the diameter of the arcuate surface of roll support 120 to provide reinforcement along both the base and sidewalls of the arcuate area. Additionally, the sidewalls of roll support 120 are further strengthened by pyramidal cavity 124, which is formed as a four sided pyramid-like recess and thereby having significant strength due to the distribution of the forces attributed to the tetrahedron design. Further strength is provided by forming indentation 122 vertically interposed within sidewall 112, generally equidistant between roll supports 120, thereby resisting compression of the ends of the roll support sections 120. Additional indentations 122 are co-located within end wall 114 in order to angularly brace the distal end of roll separator 100 due to the absence of pyramidal cavity 124.

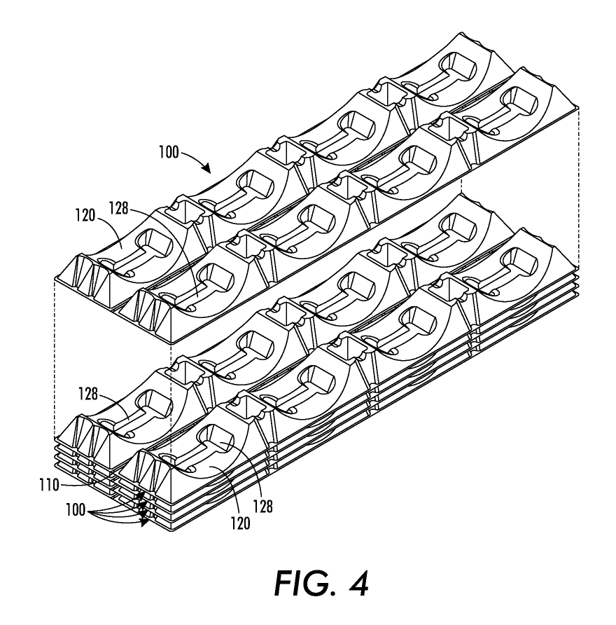

In addition to indentations 122, sidewall and end wall 112 and 114 respectively, include a draft angle represented as 126, which is characterized by an inward vertical slope as referenced to base 106, of at least about 20 degrees and more particularly about 22 degrees. The purpose of draft angle 126 is two fold. First, the slant provides for improved strength by placing the sidewall in compression and thereby reducing the bending moment, and second, a tapered sidewall promotes the ability to readily stack roll spacers 100 as depicted for example in FIG. 4

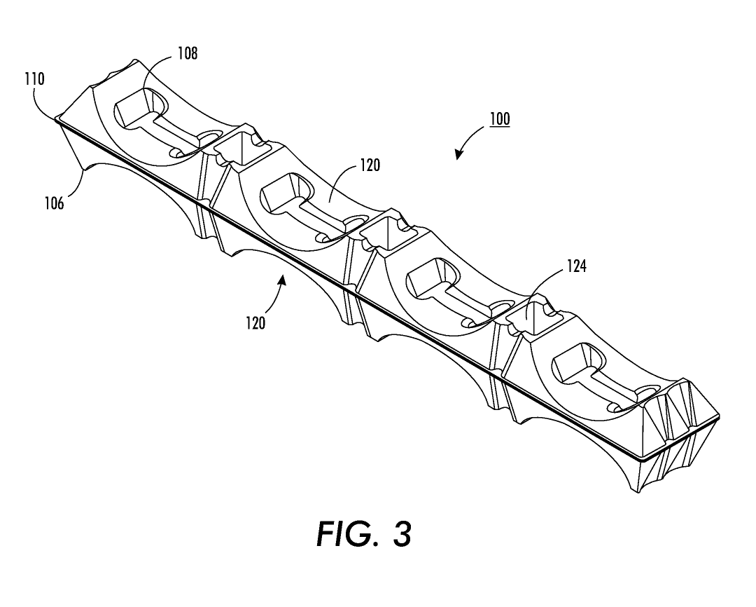

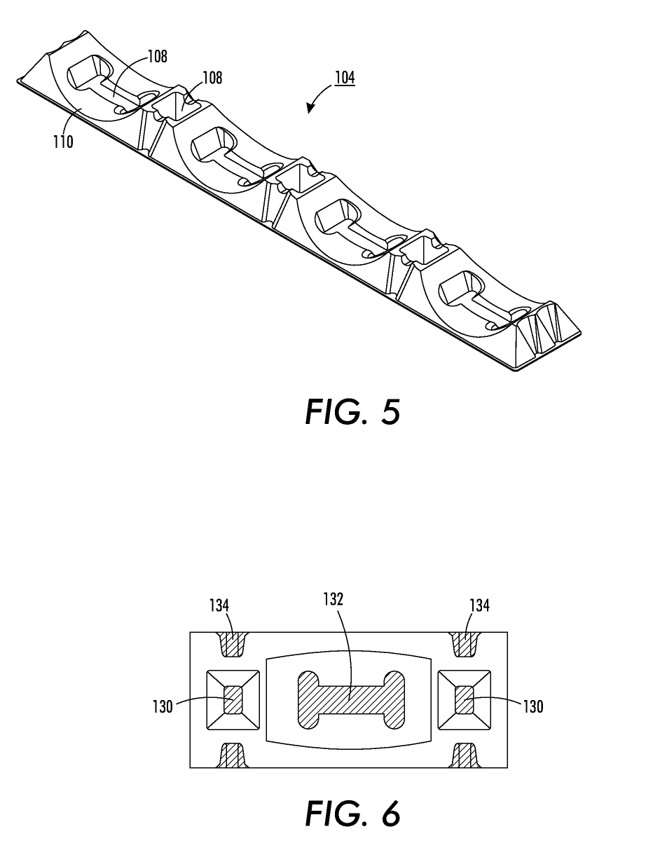

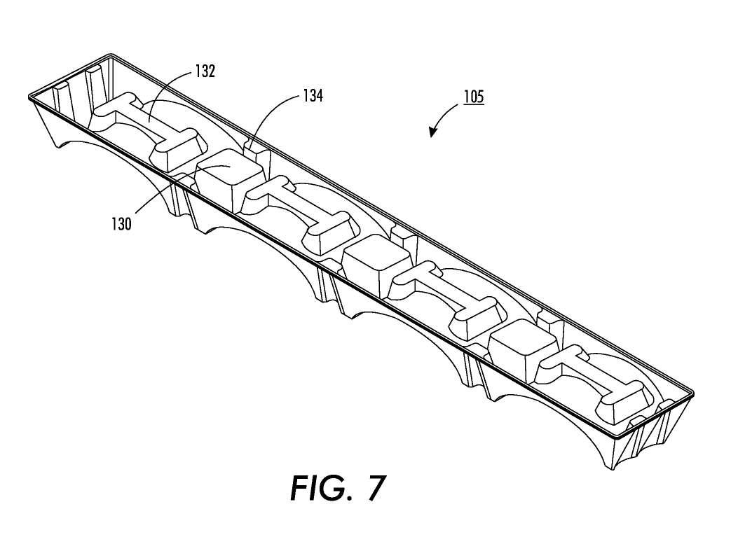

Referring briefly to FIG. 3, roll separator 100 is shown as a roll support by folding the backs of base portions 106 and 108 toward one another. Lower base portion 106 and upper base portion 108 of roll separator 100, are depicted as folded in half, to transform the pair from a side-by-side configuration to a back-to-back unit. Once folded for use separator 100, as will be noted from FIGS. 6 and 7 (which represents the underside of a single roll support surface 105), includes distinct load bearing surfaces such as pyramid tops 130 dog bone cavity bottom 132 and the base edges and indents 122, as shown by hash marks in FIG. 6. The rationale of having these points of contact therebetween lower portion 106 and top portion 108 is to allow the load forces to be transmitted throughout the stack and thereby prevent the collapsing of separator 100. Additionally, as previously mentioned, the base portions 106 and 108 are also severable along the hinge point, as shown in FIG. 5, so they may be used singularly for the first (bottom) and last (top) layer of palletized rolls as depicted in FIG. 9, for example. Referring briefly to FIG. 9, there is depicted a palletized stack of rolls 200, maintains in a spaced-apart and regular arrangement by separators 100 and strapped to pallet 210 using at least two binding straps 212 or similar devices to hold the stack together.

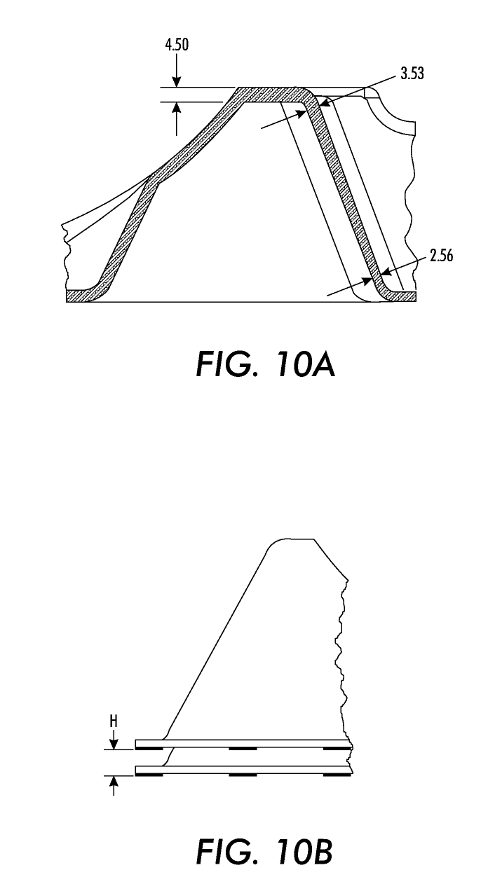

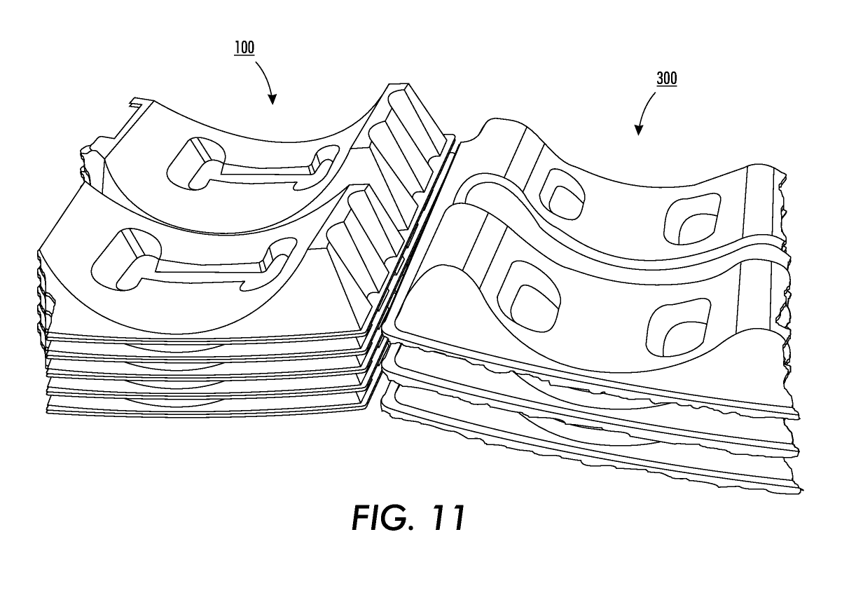

Referring to FIG. 11, there are shown conventional roll separators 300 (right side of illustration) that include a random array of fiber material, typically a cellulose or pulp mixture, that has a tendency to obstruct and impede the close nesting of separators into one another as contrasted to the separators 100 as seen on the left side of FIG. 11. Referring also to FIG. 4, in order to minimize the volume or height of a separator stack 115 it is desirable to reduce or eliminate the irregular nature of the undersurface of a fiber formed separators. The conventional process deposits a pulp mash on a surface of the screen-like mold by selectively pumping pulp saturated fluid from the reverse side. While this process provides for a smooth upper surface, the underside remains irregular. To that end it has been discovered that by applying a forming die to the underside, as a secondary operation after molding but just prior to separation from the mold and before drying, the irregular rear surface (underside) of the separator is eliminated. Moreover, the secondary compaction of the molded separator provides a more controlled wall thickness (shaded region of FIG. 10A of between about 2.0 mm (0.079 in) to about 5.0 mm (0.197 in), and preferably about 2.5 mm (0.098 in) to about 4.6 mm, (0.181 in) as depicted for example in FIG. 10A. Given this controlled thickness the ultimate stack height of a plurality of separators is substantially equal to (N)(t), where N equals the number of separators and t the maximum top thickness of each (assuming the side thicknesses are no greater than the top thickness of about 5.0 mm.

As illustrated in FIGS. 4, 10B and 11 (left side), the improved nesting capability of the separators results in a reduced stacking height. For example, one separator is nestable within a second similar separator, etc. as depicted in FIG. 10B, such that two nested separators occupy a height “H” of about 8-10 mm of height greater than what a single separator occupies. In other words, a separator adds about 12%-19% of the height of a single separator or a pair of nested separators is less than about 1.2 times the height of a single separator. As noted previously, this nesting capability for fiber-formed separators permits more separators to be stored or shipped in the same space occupied by conventional separators. Referring to FIG. 11, as the improved separators 100 on the left are compared to conventional separators 300 on the right, the improved separators result in the ability to stack two to three times more separators in the same space.

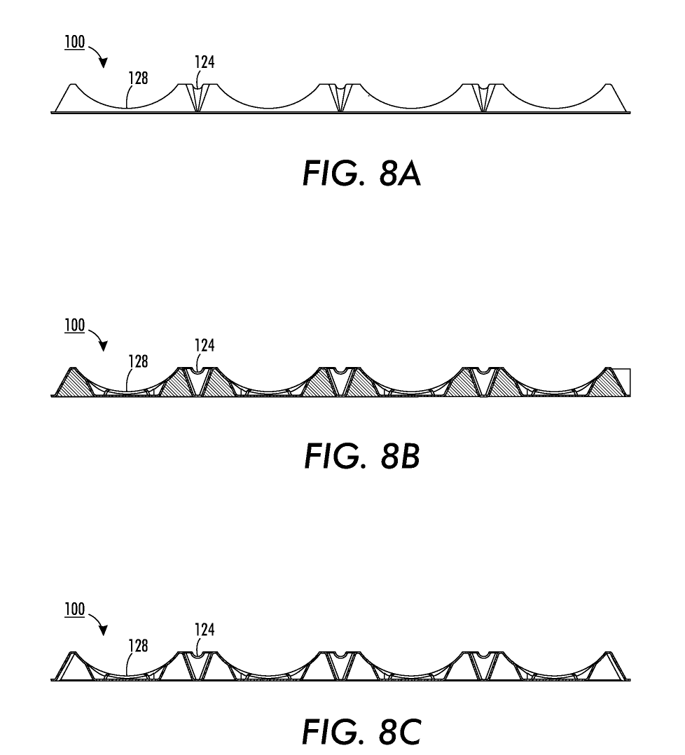

An additional benefit to the post forming and compacting operation of roll separator 100 is an increase in the average density of the walls for the separators. FIGS. 8A-C characterize cross-sectional views along the line depicted in FIG. 2. FIG. 8B shows a variable shaded region that represents a considerable amount of captive air, as might be expected prior to the post-forming compression operation, whereas FIG. 8C shows a compacted wall thickness having dimensions similar to those described above and depicted in FIG. 10A. However, as represented by FIG. 8C, the density achieved using a post forming compaction operation not only controls the wall thickness but results in separator 100 exhibiting an improved wall density, achieved using the wet pressing operation. In one embodiment the separator exhibits an average wall density of at least about 5.5 grams/cubic in. (equivalently ˜30 lbs/ft³, or ˜484.4 kg/m³)., preferably at least about 7.0 grams/cubic in. (˜32 lbs/ft³ or 512.6 kg/m³) and more preferably at least about 7.9 grams/cu in (˜34 lbs/ft³ or ˜514.6 kg/m³). Moreover, it is possible, perhaps through alternative processing techniques such as concurrent pressing and drying operations, to achieve densities even greater than 7.9 grams/cu in. (˜34 lbs/ft³ or ˜514.6 kg/m³), which may also be suitable for use in forming the disclosed separators.

In summary, the disclosed method and product resulting from compaction represent a significant improvement over the prior art based on a number of factors. The close nesting of the separators now allows for a reduction in overall mass volume thereby reducing storage space and transportation costs. The increase in material density provides for a stronger separator while using substantially the same volume of material. Lastly, the uniform material thickness of separator 100, resulting from compaction, reduces the occurrence of stress risers, or unevenly distributed forces, by eliminating voids and fractures in the material which results in a localized increase in stress, which will ultimately exceed the material's cohesive strength causing a breaking apart of separator 100.

It will be appreciated that various of the above-disclosed embodiments and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

What is claimed is:

1. A fiber-formed separator for restraining a tiered stack of items, said separator comprising:
an elongated member having a face side surface and an opposing back side surface;
a plurality of arcuate contact surfaces on the first side of the elongated member, disposed to receive and maintain separation of the items;
a divider cavity, extending between the arcuate contact surfaces and having a depression therein;
a longitudinal reinforcing recess formed within the arcuate contact surface;
an outer wall, extending about the entire periphery of said elongated member, where said outer wall has an inward draft of at least about 20 degrees; and
the separator having a thickness, between the face side surface and the back side surface, between about 2.0 mm (0.079 in) to about 5.0 mm (0.197 in), to enable substantial nesting of the separator.

2. The separator according to claim 1 wherein the separator is formed entirely from a cellulous fiber material.

3. The separator according to claim 2 wherein the average material thickness is less than about 5.0 mm.

4. The separator according to claim 2 wherein the material density is at least about 5.5 grams/cubic in.

5. The separator according to claim 2 wherein the material density is at least about 7.0 grams/cubic in.

6. The separator according to claim 2 wherein the material density is at least about 7.9 grams/cubic in.

7. The separator according to claim 1 wherein said outer wall includes a plurality of indentations for reinforcement of said outer wall.

8. A plurality of fiber-formed separators for restraining a tiered stack of generally cylindrical items, each of said separators comprising:
an elongated member having a face side and an opposing back side surface;
a plurality of arcuate item contact surfaces on the first side of the elongated member, disposed to receive and separate the generally cylindrical items;
a divider cavity, extending between the arcuate item contact surfaces and having a depression therein;
a longitudinal reinforcing recess formed within each arcuate item contact surface;
an outer wall, extending about the entire periphery of said elongated member, where said wall has an inward draft of at least about 20 degrees; and
the separator having an average material density of at least about 5.5 grams/cubic in.

9. The separators according to claim 8, wherein each separator is nestable within another of the plurality of separators such that the nested separators occupy less than about 1.2 times the height of each separator.

10. The separators according to claim 8 wherein each separator is formed from a material including cellulous fiber.

11. The separators according to claim 10 wherein the average material thickness of each separator is less than about 5.0 mm.

12. The separators according to claim 10 wherein the average material density of each separator is at least about 7.0 grams/cubic in.

13. The separators according to claim 10 wherein the average material density of each separator is at least about 7.9 grams/cubic in.

14. The separators according to claim 8, wherein said longitudinal reinforcing recess includes a dog bone shaped cavity.

15. The separators according to claim 8 wherein said outer wall includes a plurality of indentations for reinforcement of said outer wall.

16. The separators according to claim 7, wherein the face side surface is formed by depositing the material on a surface of a screen-like mold and where the opposing back side surface is formed by a secondary pressing operation applied post-molding but prior to separation from the screen-like mold.
